(19) United States
(12) Patent Application Publication
(10) Pub. No.: US 2012/0231115 A1
(43) Pub. Date: Sep. 13, 2012

(54) Grandma B's Pecan Caramel and Cinnamon Roll Kit

(76) Inventor: Barbara A. Bloir, Payson, AZ (US)

(21) Appl. No.: 13/414,173

(22) Filed: Mar. 7, 2012

Related U.S. Application Data
(60) Provisional application No. 61/464,655, filed on Mar. 7, 2011.

(51) Int. Cl. A21D 6/00; A21D 8/04

(52) U.S. Cl. 426/21; 426/62

(57) ABSTRACT

The invention provides a packaged kit featuring premeasured ingredients to easily and expediently create a scrumptious selection of pecan caramel cinnamon rolls. Each Grandma B's Pecan Caramel and Cinnamon Roll Kit is comprised of five individually packaged items and instructions to make the cinnamon rolls.

### CLAIM OF PRIORITY

This patent application claims priority under 35 USC 119 (e) (1) from U.S. Provisional Patent Application Ser. No. 61/464,655 filed Mar. 7, 2011, of common inventorship herewith entitled, “Grandma B's Pecan Caramel and Cinnamon Roll Kit.”

### FIELD OF THE INVENTION

The present invention pertains to the field of food supplies, and more specifically to the field of food preparation kits for a baked gourmet treat.

### BACKGROUND OF THE INVENTION

The prior art has put forth several designs for food preparation kits for cooking. Among these are:

U.S. Pat. No. 7,141,255 to Debbie Glassberg, Cheryl Lillienthal, Debbie L. Lohmeyer, Julene A. Mrzywka and Theodore R. Herrera describes food formulations for preparation by young children requiring only the addition of water to produce edible foods such as brownies, dessert gels, smoothies, milkshakes, fondues and sorbets. Kitchen play sets with appropriate appliances and utensils may also be available with these food formulations.

U.S. Pat. No. 6,372,272 to Mark S. Honoosic describes a food kit comprising a decorative can or container which includes dry packaged cake mix and a package of premixed icing. The cake can be baked and stored in the container. The outer wall of the container is decorated with a heat resistant paint.

U.S. Pat. No. 5,045,333 to Robert Petrofsky and David Petrofsky describes a container of ingredients for an iced bakery good and a method of icing a bakery good. The container comprises a first compartment which can hold batter or dough during baking. A second removable compartment is attached to the first compartment and has a layer of icing which can be directly applied to the freshly baked good by orienting the second compartment over the first compartment. Heat rising from the baked good heats the icing which separates from the surface of the second compartment and coats the top side of the baked good.

None of these prior art references describe the present invention.

### SUMMARY OF THE INVENTION

It is an object of the present invention to provide a convenient food preparation kit to bake and serve a delicious gourmet treat.

### BRIEF DESCRIPTION OF THE DRAWINGS

FIG. 1 is a top perspective view of the present invention showing a package cover with a logo and picture, and the side of the baking pan covered by the package cover.

FIG. 2 is a top perspective view of the present invention with the package cover removed, showing the five bags comprising this invention.

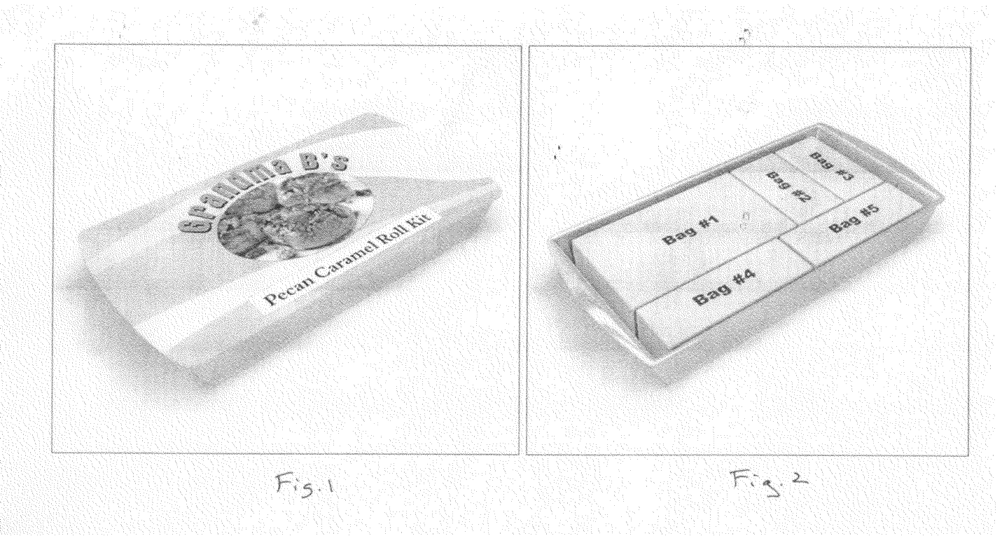

### DETAILED DESCRIPTION OF THE INVENTION

Dessert is a course that typically comes at the end of a meal, usually consisting of sweet food item. While most desserts serve as a separate and final sweet course, some cuisines mix sweet and savory dishes throughout the meal. The dessert often is a separate meal or snack rather than a course and is eaten apart from the meal. The present invention, hereinafter referred to as Grandma B's Pecan Caramel and Cinnamon Roll Kit, is a packaged kit featuring premeasured ingredients to easily and expediently create a scrumptious selection of pecan caramel cinnamon rolls. Each Grandma B's Pecan Caramel and Cinnamon Roll Kit is comprised of five individually packaged items. Bag One comprises approximately three cups and one tablespoon of flour, one and one third cups sugar, one tablespoon dried yeast, and one teaspoon salt. Bag Two comprises one cup brown sugar. Bag Three comprises two tablespoons cinnamon. Bag Four comprises one cup brown sugar. Bag Five comprises one cup pecan pieces. These bags are packed into a handy baking pan to comprise the present invention. This baking pan features an interior area approximately nine inches by twelve inches. Total dimensions of this baking pan measure approximately fifteen inches in length, nine inches in width, and two inches in depth. Included with Grandma's Pecan Caramel and Cinnamon Roll Kit is an easily followed recipe featuring additional ingredients and instructions for baking. The additional ingredients to be supplied by the baker are approximately one cup and one tablespoon whole milk, one egg, one and one half cups butter, three tablespoons corn syrup, a pot, a rolling pin, a mixing bowl, a greased bowl and a clean small cotton towel.

The preparation of the Grandma B's Pecan Caramel and Cinnamon Rolls is simple and straightforward. To start the actual preparation regimen, the milk and approximately three tablespoons of butter are placed into the pot and heated until warm. Removing the mixture from the heat, the user adds the egg and beats the concoction until mixed well. Next, the user adds the contents of Bag One to this mixture and beats the mixture by hand or a mixer until a stiff dough forms. This portion is placed into the greased bowl and covered with a towel, then left to rise in a warm area. This warm area must be approximately eighty degrees with no drafts. The top of a warm oven is a preferred area. The dough will double in size in approximately one to two hours.

During the next stage of preparation, the rolling pin is coated with flour. Additional flour is spread on a working surface large enough to accommodate the prepared dough. After kneading the dough to remove stickiness, adding flour if needed, the user rolls out the dough to dimensions of approximately sixteen inches in length and twelve inches in width. The user spreads the softened butter over the rolled out dough. Opening Bag Two, the user evenly spreads the brown sugar on top of the butter. Opening Bag Three, the user sprinkles the cinnamon over the brown sugar. The user then folds the dough lengthwise and pushes the dough forward to create a jellyroll that is approximately twelve inches in length. The user then slices this jellyroll into approximately twelve evenly sized cross sections.

Before baking, the user mixes the contents of Bag Four and Bag Five with one cup of butter and three tablespoons of corn syrup and melts this mixture on a stove or in a microwave. After evenly spreading this mixture on the bottom of the baking pan provided in the kit, the user arranges the cut rolls on top and covers them with a towel. These rolls are left to rise and double in size which takes approximately one to one and a half hours. The rolls are baked in an oven at approximately three hundred seventy five degrees for twenty to twenty five minutes until golden brown. The process of baking these delicious rolls can provide fun entertainment for parents and children. Facilitating the creation of gooey delicious sweet rolls, the Grandma B's Pecan Caramel and Cinnamon Roll Kit is an intriguingly tasteful alternative to common cake and pie dessert choices. Whether enjoyed in conjunction with a large family meal or simply as a midnight treat, this product proves a palatable contribution to virtually any meal or snack.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A food preparation kit for preparing and baking pecan caramel cinnamon rolls comprising: five individually packaged premeasured ingredients, wherein
Bag One comprises approximately three cups and one tablespoon of flour, one and one third cups sugar, one tablespoon dried yeast, and one teaspoon salt;
Bag Two comprises one cup brown sugar;
Bag Three comprises two tablespoons cinnamon;
Bag Four comprises one cup brown sugar; and
Bag Five comprises one cup pecan pieces.

2. The kit of claim 1 wherein the 5 bags are packed into a baking pan wherein the interior of the pan measures approximately nine inches by twelve inches, and two inches in depth.

3. The kit of claim 2 wherein the overall outer dimensions of the baking pan are approximately fifteen inches in length, nine inches in width, and two inches in depth.

4. The kit of claim 1 further comprising a recipe requiring additional ingredients and instructions for baking, wherein the additional ingredients to be supplied by the baker are approximately one cup and one tablespoon whole milk, one egg, one and one half cups butter, three tablespoons corn syrup, a pot, a rolling pin, a mixing bowl, a greased bowl and a clean small cotton towel.

5. A method of making cinnamon rolls comprising:
placing the milk and approximately three tablespoons of butter are placed into the pot and heated until warm;
removing the mixture from the heat, the adding the egg and beating the mixture until mixed well;
adding the contents of Bag One to this mixture and beating the mixture by hand or a mixer until a stiff dough forms;
placing the dough into a greased bowl and covering with a towel, then leaving the mixture to rise in a warm area, wherein the warm area must be approximately eighty degrees with no drafts, wherein the dough will double in size in approximately one to two hours;
coating a rolling pin with flour;
spreading flour on a working surface large enough to accommodate the prepared dough;
kneading the dough to remove stickiness, adding flour if needed;
rolling out the dough to dimensions of approximately sixteen inches in length and twelve inches in width;
spreading the softened butter over the rolled out dough;
opening Bag Two, and evenly spreading the brown sugar on top of the butter;
opening Bag Three, sprinkling the cinnamon over the brown sugar;
folding the dough lengthwise and pushing the dough forward to create a jellyroll that is approximately twelve inches in length;
slicing the jellyroll into approximately twelve evenly sized cross sections;
mixing the contents of Bag Four and Bag Five with one cup of butter and three tablespoons of corn syrup and melting this mixture on a stove or in a microwave;
spreading this mixture evenly on the bottom of the baking pan provided in the kit and arranging the cut rolls on top and covering them with a towel;
allowing the rolls to rise and double in size which takes approximately one to one and a half hours;
baking the rolls in an oven at approximately three hundred seventy five degrees for twenty to twenty five minutes until golden brown.
